(19) United States
(12) Patent Application Publication
(10) Pub. No.: US 2020/0076960 A1
(43) Pub. Date: Mar. 5, 2020

(54) INFORMATION PROCESSING SYSTEM AND METHOD OF CONFIRMING OPERATION HISTORY

(71) Applicant: SHARP KABUSHIKI KAISHA, Osaka (JP)

(72) Inventors: MAYUKO YOSHIDA, Osaka (JP); TAKASHI SAWANO, Osaka (JP)

(21) Appl. No.: 16/555,980

(22) Filed: Aug. 29, 2019

(30) Foreign Application Priority Data
Aug. 31, 2018 (JP) 2018-162853

(51) Int. Cl. H04N 1/00; H04M 3/51

(52) U.S. Cl. CPC H04N 1/00079; H04N 1/00411; H04M 3/5183; H04N 1/00076; H04N 1/00015

(57) ABSTRACT

This information processing system includes a call center terminal and an image forming apparatus. The image forming apparatus includes a display, and receives a user operation via a plurality of operation screens displayed on the display. Operation history image data related to an operation history image, which includes a moving image or a capture image corresponding to the operation history of a user who is using the image forming apparatus from when an operation for executing a predetermined job is started, is generated. The operation history image data is transmitted to the call center terminal, and the operation history image corresponding to the user's operation history is displayed on a display of the call center terminal.

### BACKGROUND OF THE INVENTION

Field of the Invention

The present invention relates to an information processing system and a method of confirming an operation history, more specifically, to an information processing system which receives a user operation via a graphical user interface (GUI) and a method of confirming an operation history.

### Description of the Background Art

An example of the background art of this field is disclosed in

Japanese Unexamined Patent Application Publication No. 2013-045200. This publication discloses a support service system including an image forming apparatus, and a call center terminal device capable of communicating with the image forming apparatus. In the support service system of the background art, when the image forming apparatus receives a predetermined command from the call center terminal device, screen image data of a display device, user operation information relating to an input device, and data such as state information of the image forming apparatus are transmitted to the call center terminal device.

However, in the support service system of the background art, since the screen image data or the like of the display device obtained after a command has been received is transmitted to the call center terminal device, it is not possible to understand what operation had been performed by the user to reach the current screen before the command is received. Therefore, the above support service system has a problem that appropriate guidance cannot be provided to the user.

Accordingly, the main object of the present invention is to provide a novel information processing system and a novel method of confirming an operation history.

Another object of the present invention is to provide an information processing system and a method of confirming an operation history with which the user's operation history can be identified easily and accurately in a GUI including a plurality of operation screens.

### SUMMARY OF THE INVENTION

A first invention is an information processing system which includes: an image forming apparatus capable of executing a predetermined job; an information processor operated by an operator of a call center; and a storage, in which the image forming apparatus includes a first display, a first display controller, and a generator. The first display controller causes an operation screen to be displayed on the first display by switching a plurality of operation screens for executing the predetermined job. The generator generates an operation history image corresponding to a user's operation history from when an operation for executing the predetermined job is started. The storage stores the operation history image generated by the generator. The information processor includes a second display, an acquirer, and a second display controller. The acquirer accesses the storage to acquire the operation history image. The second display controller causes the operation history image acquired by the acquirer to be displayed on the second display.

A second invention is the information processing system dependent from the first invention, in which the information processor further includes an operation portion which receives an operation of the operator, and the acquirer accesses the storage when the operation portion has received a predetermined operation.

A third invention is the information processing system dependent from the first or second invention, in which the storage is provided in the image forming apparatus.

A fourth invention is the information processing system dependent from the first or second invention, in which the information processing system further includes a server provided to be communicable with the image forming apparatus and the formation processor, and the storage is provided in the server.

A fifth invention is the information processing system dependent from any one of the first to fourth inventions, in which the operation history image includes a moving image corresponding to the operation screen displayed on the first display from when the operation for executing the predetermined job is started.

A sixth invention is the information processing system dependent from any one of the first to fourth inventions, in which the operation history image includes a plurality of still images corresponding to the operation screen displayed on the first display from when the operation for executing the predetermined job is started.

A seventh invention is a method of confirming an operation history in an information processing system including: an image forming apparatus, which is provided with a first display and is capable of executing a predetermined job; an information processor, which is provided with a second display, and is operated by an operator of a call center; and a storage, the method including: (a) a step of causing an operation screen to be displayed on the first display by switching a plurality of operation screens for executing the predetermined job; (b) a step of generating an operation history image corresponding to a user's operation history in the image forming apparatus from when an operation for executing the predetermined job is started; (c) a step of causing the operation history image, which is generated in step (b), to be stored in the storage; (d) a step of causing the information processor to access the storage and acquire the operation history image; and (e) a step of causing the operation history image, which is acquired by information processor in step (d), to be displayed on the second display.

According to the present invention, in a GUI including a plurality of operation screens, the user's operation history can be identified easily and accurately.

The object as described above, other and further objects, features and advantages of the present invention will become more evident from the detailed description of the embodiments given below with reference to the accompanying drawings.

### BRIEF DESCRIPTION OF THE DRAWINGS

FIG. 1 is a diagram showing one example of the structure of an information processing system of the present invention;

FIG. 2 is a block diagram showing the electrical configuration of a call center terminal shown in FIG. 1;

FIG. 3 is a block diagram showing the electrical configuration of an image forming apparatus shown in FIG. 1;

FIG. 4 is an explanatory diagram showing one example of a home screen;

FIG. 5 is an explanatory diagram showing one example of a copy setting screen;

FIG. 6 is an explanatory diagram showing one example of a memory map of RAM of the call center terminal shown in FIG. 2;

FIG. 7 is an explanatory diagram showing one example of a memory map of RAM of the image forming apparatus shown in FIG. 3;

FIG. 8 is a flow chart showing one example of information processing of a CPU of the image forming apparatus shown in FIG. 3;

FIG. 9 is a flow chart showing one example of information processing of a CPU of the call center terminal shown in FIG. 2;

FIG. 10 is an explanatory diagram showing one example of a copy setting screen in a second embodiment;

FIG. 11 is a flow chart showing an example of information processing of a CPU of an image forming apparatus of the second embodiment;

FIG. 12 is a diagram showing one example of the structure of an information processing system of a third embodiment;

FIG. 13 is a flow chart showing one example of information processing of a CPU of an image forming apparatus of the third embodiment; and

FIG. 14 is a flow chart showing one example of information processing of a CPU of a call center terminal of the third embodiment.

### DESCRIPTION OF THE PREFERRED EMBODIMENTS

### First Embodiment

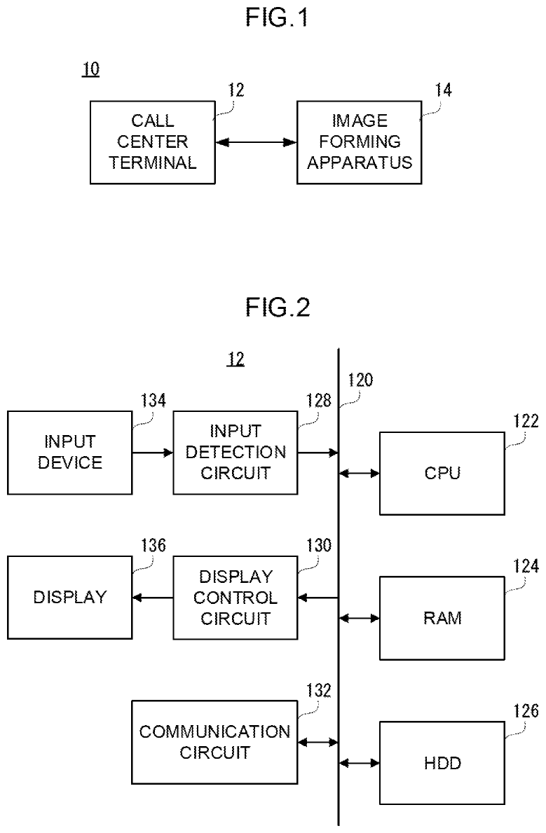

FIG. 1 is a diagram showing one example of the structure of an information processing system 10 of the present invention. Referring to FIG. 1, the information processing system 10 corresponding to a first embodiment of the present invention includes a call center terminal 12 and an image forming apparatus 14. The call center terminal 12 and the image forming apparatus 14 are communicably connected to each other via a network such as the Internet and a LAN.

Although FIG. 1 shows one image forming apparatus 14, the number of image forming apparatuses 14 may be two or more.

The call center terminal 12 is a general-purpose computer (terminal) used by an operator of a call center. Specifically, the call center terminal 12 corresponds to a desktop PC, a notebook (laptop) PC, a tablet PC, and the like.

FIG. 2 is a block diagram showing the electrical configuration of the call center terminal 12 shown in FIG. 1. Referring to FIG. 2, the call center terminal 12 includes a CPU 122. A RAM 124, an HDD 126, an input detection circuit 128, a display control circuit 130, and a communication circuit 132 are connected to the CPU 122 via a bus 120. Further, an input device 134 is connected to the input detection circuit 128, and a display 136 is connected to the display control circuit 130. As the display 136, for example, an LCD, an electroluminescent (EL) display, or the like, can be used. The input device 134 is, for example, a keyboard and/or a computer mouse. When the input device 134 is a keyboard, the input device 134 includes hardware operation buttons or operation keys. Further, as the input device 134, a touch panel may also be used. As the touch panel, a touch panel of arbitrary type such as a capacitive type, an electromagnetic induction type, a resistive type, or an infrared type can be employed, and the touch panel is provided on a display surface of the display 136. Alternatively, a touch panel display in which the touch panel and the display 136 are integrally formed may be used.

The CPU 122 manages overall control of the call center terminal 12. The RAM 124 is used as a work area and a buffer area of the CPU 122.

The HDD 126 is a main storage device of the call center terminal 12, and stores, as appropriate, a control program for the CPU 122 to control the operation of each part of the call center terminal 12, and display image data or the like related to various screens. Alternatively, instead of the HDD 126 or together with the HDD 126, the other non-volatile memories such as an SSD, a flash memory, and an EEPROM may be used.

The input detection circuit 128 outputs, to the CPU 122, an operation signal or operation data corresponding to the operation of the input device 134 described above.

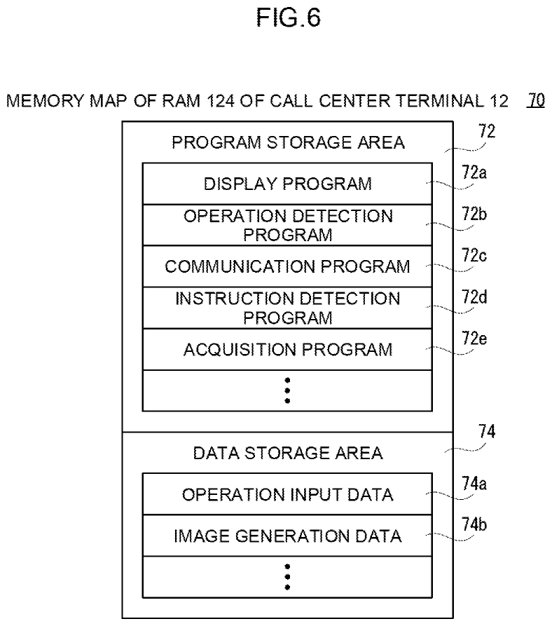

The display control circuit 130 includes a CPU, a VRAM, and the like. Under the instruction of the CPU 122, the GPU generates, in the VRAM, display image data for displaying various screens on the display 136 by using image generation data 74b (FIG. 6) stored in the RAM 124. Further the GPU outputs the generated display image data to the display 136.

The communication circuit 132 is a communication circuit for establishing connection to a network such as the Internet. The communication circuit 132 is a wired communication circuit or a wireless communication circuit, and the communication circuit 132 communicates with an external device such as the image forming apparatus 14 via a network, in accordance with an instruction from the CPU 122.

Note that the electrical configuration of the call center terminal 12 shown in FIG. 2 is merely an example, and is not necessarily limited to the illustrated configuration. Further, although not shown, a call center calling device is provided along with the call center terminal 12. The call center calling device is a general-purpose calling device used by the operator of the call center, and is, for example, a telephone or a headset. Also, the call center calling device includes a small liquid crystal display. When the call center calling device and another calling device are connected, in other word, when a talk is enabled between the call center calling device and another calling device, information on the calling device that is connected to the call center calling device (i.e., the calling device of a connection destination) is displayed on the liquid crystal display for the operator of the call center. Therefore, the operator of the call center can recognize the information on the calling device of the connection destination.

Returning to FIG. 1, the image forming apparatus 14 is a multifunction peripheral (MFP) having a copy function, a printer function, a scanner function, a facsimile (Fax) function, Internet Fax (I-Fax) function, and the like.

Further, the image forming apparatus 14 is placed in a store such as a supermarket, a restaurant, or a convenience store, and in a public facility such as a station, a bus terminal, an airport, a public office, or a library. The image forming apparatus 14 provides various types of information or predetermined service (function) to a user according to the location where the image forming apparatus 14 is placed.

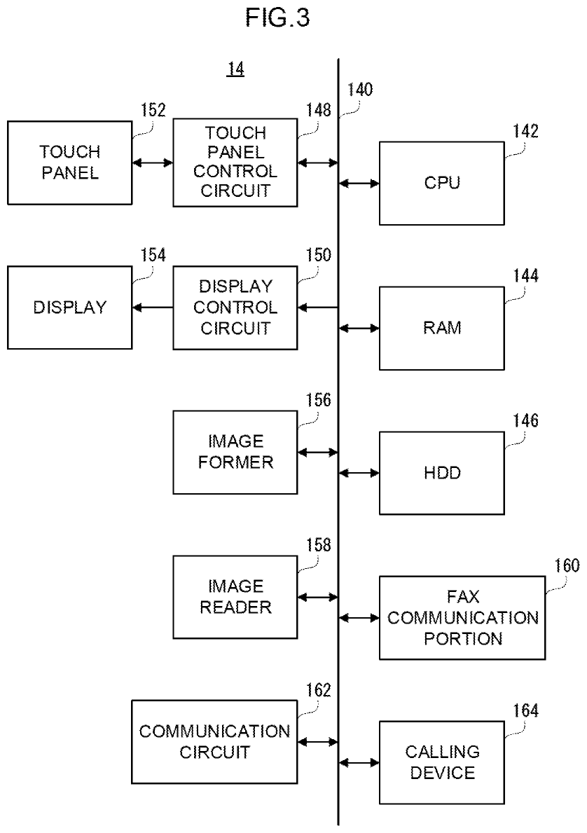

FIG. 3 is a block diagram showing the electrical configuration of the image forming apparatus 14 shown in FIG. 1. Referring to FIG. 3, the image forming apparatus 14 includes a CPU 142. A RAM 144, an HDD 146, a touch panel control circuit 148, a display control circuit 150, an image former 156, an image reader 158, a Fax communication portion 160, a communication circuit 162, and a calling device 164 are connected to the CPU 142 via a bus 140. Further, a touch panel 152 is connected to the touch panel control circuit 148 and a display 154 is connected to the display control circuit 150.

The CPU 142 manages overall control of the image forming apparatus 14. The RAM 144 is used as a work area and a buffer area of the CPU 142. The HDD 146 is a main storage device of the image forming apparatus 14, and stores, as appropriate, a control program for the CPU 142 to control the operation of each part of the image forming apparatus 14, and display image data or the like related to various screens. Alternatively, instead of the HDD 146 or together with the HDD 146, the other non-volatile memories may be used.

The touch panel control circuit 148 applies a voltage or the like that is necessary to the touch panel 152. In addition to the above, when a touch operation (touch input) within a touch effective range of the touch panel 152 is detected in the touch panel 152, the touch panel control circuit 148 outputs touch coordinate data indicating the position of the detected touch input to the CPU 142.

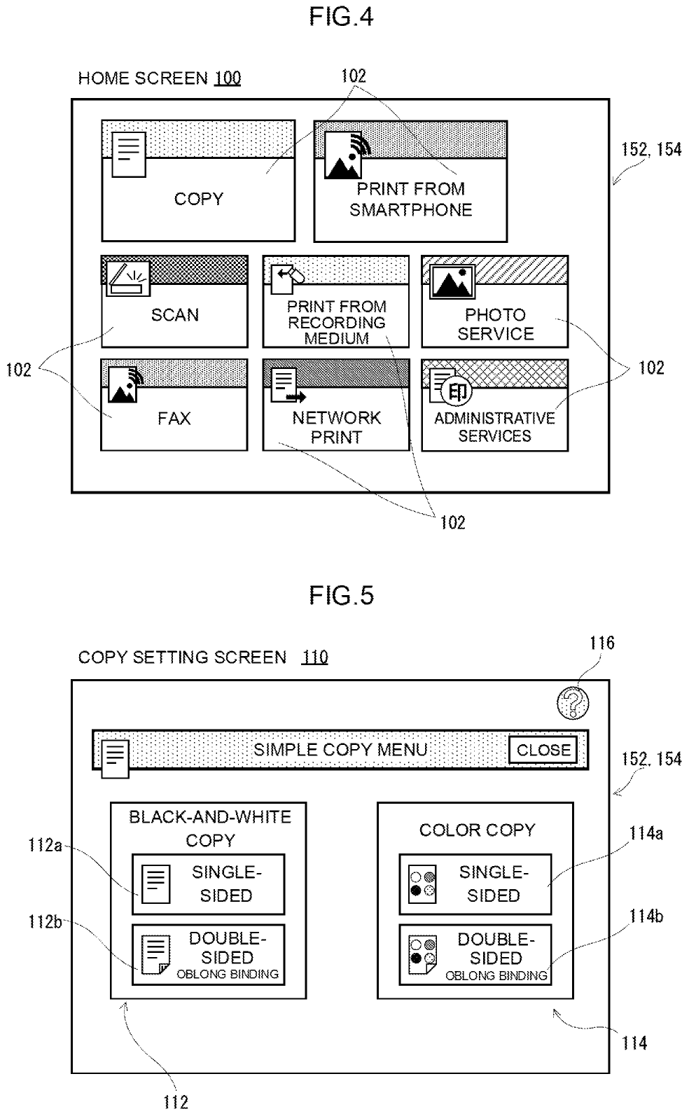

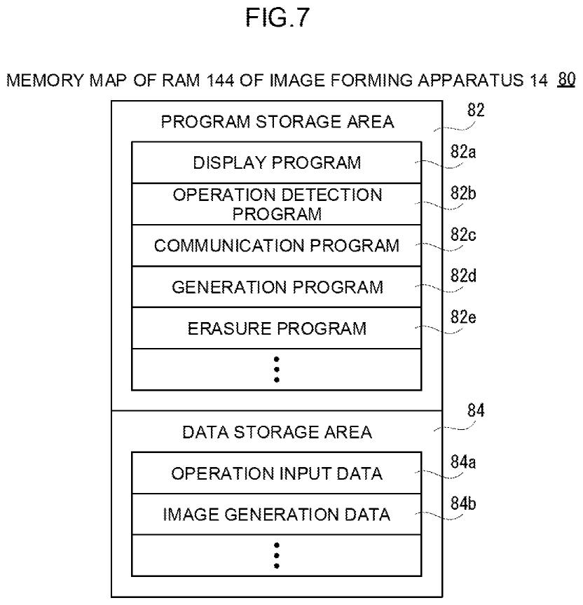

The display control circuit 150 includes a GPU a VRAM, and the like. Under the instruction of the CPU 142, the CPU generates, in the VRAM, display image data for displaying various screens on the display 154 by using image generation data 84b (FIG. 7) stored in the RAM 144. Further the CPU outputs the generated display image data to the display 154. The display 154 displays software keys, messages, and the like for reflecting various settings in the image forming apparatus 14 or receiving print instructions, etc., from the user. As one example, the display 154 displays an operation screen for executing a desired job from various jobs corresponding to services that can be executed by the image forming apparatus 14. The operation screen includes a home screen 100 (FIG. 4), which is a screen for selecting a job, a setting screen for setting the operating condition of each job, and the like. However, in the first embodiment, the software key refers to, for example, a key (icon) reproduced by software on a display surface of the display 154. Also, the job means copying (including scanning of a document), printing, sending a Fax, scanning, and the like.

The image reader 158 includes a light source, a plural of mirrors, an imaging lens, a line sensor, and the like. The image reader 158 exposes a surface of a document to light by the light source, and guides reflected light reflected from the surface of the document to the imaging lens by the plurality of mirrors. Further, the reflected light is focused on a light receiving element of the line sensor such as a charge-coupled device (CCD) or a contact image sensor (CIS) by the imaging lens. In the line sensor, brightness and chromaticity of the reflected light focused on the light receiving element are detected, and read image data based on an image of the surface of the document is generated.

The image former (printer) 156 is a general-purpose laser printer, and includes a photoreceptor, a charger, an exposure device, a developing device, a transfer device, a fixing device, etc., and prints an image corresponding to print data processed by an image processing circuit on recording paper (paper sheet).

Although detailed explanation is omitted, the image former 156 has a color print function, and includes four photoreceptors, four chargers, four developing devices, four intermediate transfer rollers, four cleaning devices, etc., for the respective colors of Y (yellow), M (magenta), C (cyan), and K (black). Further, an image forming station including a photoreceptor, a charger, a developing device, a transfer roller, and a cleaning device is configured for each color. For example, the image forming apparatus 14 is a tandem-type image forming apparatus, and in the image former 156, the image forming stations for the respective colors are arranged in a row. Note that the image former 156 may be configured by a sublimation printer or an ink jet printer, instead of the laser printer.

The Fax communication portion 160 includes a facsimile modem (Fax modem) and a network control unit (NCU) and is connected to a public communication line such as a public switched telephone network (PSTN) via a telephone line and a circuit switch, etc. The Fax modem modulates encoded transmission image data to an analog signal of a type suitable for transmission over the public switched telephone network, in conformity with the facsimile communication (Fax communication) standards, and also acquires received image data by demodulating the analog signal from the other Fax device. The network control unit is an element which performs line control for closing and opening the public switched telephone network, and connects the Fax modem to the public switched telephone network. In addition, the network control unit transmits and receives image data and control signals, etc., in conformity with a predetermined Fax communication protocol, and also performs automatic calling processing and automatic call receiving processing of the Fax communication.

The communication circuit 162 is a communication circuit for establishing connection to a network such as the Internet. The communication circuit 162 is a wired communication circuit or a wireless communication circuit, and communicates with an external device such as the call center terminal 12 via a network, in accordance with an instruction from the CPU 142.

The calling device 164 is a general-purpose calling device used by the user of the image forming apparatus 14 and is, for example, a telephone. The calling device 164 is provided to enable the user to have a conversation with the operator of the call center in the cases where a trouble has occurred in the image forming apparatus 14, or the user is uncertain of the service details or an operation method of the image forming apparatus 14. Also, in a case where the calling device 164 is a telephone including a receiver, as the receiver is picked up, in other words, as the receiver is brought into an off-hook state, the calling device 164 is automatically connected to the call center calling device, and the user is allowed to have a conversation with the operator of the call center. Further, unique identification information is assigned to the calling device 164, and when the calling device 164 and the call center calling device are connected, the identification information of the calling device 164 is displayed on the liquid crystal display of the call center calling device. Consequently, the operator of the call center can identify the calling device 164 connected to the call center calling device, and the image forming apparatus 14 including the calling device in question.

Note that the electrical configuration of the image forming apparatus 14 shown in FIG. 3 is merely an example, and is necessarily limited to the illustrated configuration. For example, as the other input means, a hardware operation button such as an operation panel may be provided in the image forming apparatus 14, or a hardware keyboard may be connected to the image forming apparatus 14. In addition, the image forming apparatus 14 may be provided with mounting portions (for example, a drive and a memory slot) for mounting various recording media. Various recording media include an optical disk (for example, a CD-R, a DVD-R, and a BD-R) and a flash memory (for example, a USB memory, an SD memory card, and a memory stick). Note that the optical disc is mounted in the drive. Also, the flash memory is mounted in the memory slot.

In the information processing system 10 having such a configuration, the image forming apparatus 14 receives a user operation via a GUI displayed on the display 154. Specifically, various operation screens are displayed on the display 154 of the image forming apparatus 14, and the user operation is received in accordance with a touch input made on the touch panel 152. For example, as an example of the operation screen, a home screen including a plurality of icons respectively assigned to a plurality of jobs that can be executed by the image forming apparatus 14 is displayed on the display 154. When any one of the icons is selected by the user on the home screen, various operation screens (setting screens) corresponding to the selected icon are displayed on the display 154. The image forming apparatus 14 executes a job in accordance with the specifics set on the setting screen.

Here, in the cases where a trouble has occurred in the image forming apparatus 14, or the user is uncertain of the service details or an operation method of the image forming apparatus 14, the user can have a voice conversation with the operator of the call center by using the calling device 164. Here, if the operator can identify the screen currently displayed on the image forming apparatus 14 and the user's operation history to reach the screen being displayed, the operator can provide appropriate guidance in response to the user's inquiry.

However, in a conventional image forming apparatus, the user has to explain the history or the like of the user's operation by way of voice alone to the operator, and a situation in which information is not correctly conveyed from the user to the operator may be encountered. There is a problem that the operator is unable to appropriately guide the riser in response to the user's inquiry unless the correct information is conveyed from the user to the operator.

Therefore, in the first embodiment, in a case where an inquiry is made to the call center from the user, the operator has been enabled to confirm an operation history image corresponding to the user's operation history from when an operation for executing the job is started.

Hereinafter, an operation example of the information processing system 10 will be described with reference to FIGS. 4 and 5. FIG. 4 is a explanatory diagram showing one example of the home screen 100. FIG. 5 is an explanatory diagram showing one example of a copy setting screen 110.

When the main power of the image forming apparatus 14 is turned on and the image forming apparatus 14 is in a standby state in which each function can be executed, the home screen 100 as shown in FIG. 4 is displayed on the display 154 of the image forming apparatus 14. The home screen 100 is an initial operation screen for executing various jobs, and is, more specifically, a screen for selecting a job. On the home screen 100, a plurality of icons 102 respectively corresponding to a plurality of jobs that can be executed by the image forming apparatus 14 are displayed.

Each of the plurality of icons 102 is an image surrounded by a substantially rectangular frame, and functions as a software key. Jobs such as “copy”, “scan”, “fax”, “print from recording medium”, “network print” “photo service”, “administrative services” and “print from smartphone” are assigned to the plurality of icons 102, respectively.

When the icon 102 is touched (selected) on the home screen 100, a plurality of setting screens for making the settings of the job assigned to the selected icon 102 are sequentially displayed on the display 154.

For example, when the icon 102 to which a copy job is assigned is touched on the home screen 100 when the copy job is selected), the copy setting screen 110 as shown in FIG. 5 is displayed on the display 154. The copy setting screen 110 is a screen displayed on the display 154 initially from among a plurality of setting screens for making the settings of the copy job (i.e., a plurality of operation screens related to the copy job).

The copy setting screen 110 includes a first setting area 112, a second setting area 114, and a help icon 116. The first setting area 112 and the second setting area 114 are areas for making the basic settings of the copy job. The basic settings of the copy job refer to the setting of a black-and-white copy/color copy and the setting of a single-sided copy/double-sided copy.

The first setting area 112 includes an icon 112a and an icon 112b, and is an area for making the setting of the single-sided copy/double-sided copy in the black-and-white copy. The setting of the black-and-white single-sided copy is assigned to the icon 112a. The setting of the black-and-white double-sided copy is assigned to the icon 112b.

The second setting area 114 includes an icon 114a and an icon 114b, and is an area for making the setting of a single-sided copy/double-sided copy in the color copy. The setting of the color single-sided copy is assigned to the icon 114a The setting of the color double-sided copy is assigned to the icon 114b.

The help icon 116 is arranged in an upper right portion of the copy setting screen 110. The function of instructing execution of a help mode such as searching for an FAQ is assigned to the help icon 116.

By touching any of the icon 112a, the icon 112b, the icon 114a, and the icon 114b, the basic setting of the copy job is determined. Though not illustrated, when the basic settings of the copy job are determined on the copy setting screen 110, a plurality of operation screens for setting the other operating conditions in the copy job are sequentially displayed on the display 154. Then, the copy job is executed in accordance with the operating condition set on each of the operation screens. Here, on each of the operation screens, an icon for setting the operating condition in the copy job such as the icon 112a, a help icon having the same function as that of the help icon 116, and the like are displayed.

Also, in the first embodiment, data (operation history image data) on an image (operation history image) corresponding to the user's operation history from when an operation for executing a predetermined job is started is generated (created). In the above, the time when the operation for executing a job is started means that when the job is selected, in other words, when any of the icons 102 is touched on the home screen 100. Therefore, when any of the icons 102 is touched on the home screen 100, the operation history image data is generated. The generated operation history image data is stored in the HDD 146 of the image forming apparatus 14.

The operation history image includes an image concerning a moving image or a plurality of still images (capture images) corresponding to the operation screen displayed on the display 154 from when the job is selected. When the operation history image corresponds to the plurality of capture images, the image may be captured each time the operation screen displayed on the display 154 is changed, or may be captured every predetermined period (for example, every two seconds). If the image is captured at least every time the operation screen is changed, it is possible to ascertain the user's operation. Further, if the image is captured every predetermined period, it is possible to ascertain the approximate time of display of each of the operation screens, in other words, duration of time for the user to stay on each of the operation screens.

Also, the operation history image data includes identification information for identifying the image forming apparatus 14 in which the operation history image data has been created. For example, the identification information is unique information (ID) assigned to each image forming apparatus 14. When the image forming apparatus 14 can be identified by identifying the location where the image forming apparatus 14 is installed at the call center side, the identification information may be information regarding the location where the image forming apparatus 14 is installed.

Then, the operator of the call center operates the call center terminal 12 to give a predetermined instruction (display instruction) of causing the operation history image data to be displayed on the display 136 of the call center terminal 12.

Note that the operator of the call center gives the display instruction when an inquiry is received from the user of the image forming apparatus 14. Here, since the user is talking with the operator of the call center by using the calling device 164, the operator of the call center can identify the image forming apparatus 14 provided with the calling device 164 of the calling destination, in other words, the image forming apparatus 14 being used by the user. Hence, the operator of the call center gives the display instruction by specifying the operation history image data stored in the HDD 146 of the image forming apparatus 14 being used by the user.

When the display instruction is given, a moving image or a capture image included in the specified operation history image data is displayed on the display 136 of the call center terminal 12. In other words, an image, which is the same as that of the operation screen displayed on the display 154 of the image forming apparatus 14 in response to the user operation, is displayed on the display 136 of the call center terminal 12, and the operation history image related to the user who is using the image forming apparatus 14 can be reproduced in the call center terminal 12.

Accordingly, the operator can visually recognize the user's operation history image. In this way, the operator can provide appropriate guidance in response to the inquiry from the user while referring to the user's operation history image.

Note that the operation history image data may be newly generated as the user operates the image forming apparatus 14 after the display instruction has been given, or as a predetermined time elapses. That is, the operation history image data may be updated. In this case, the moving image or the capture image displayed on the display 136 of the call center terminal 12 is periodically updated until a termination instruction to be described later is given, from when the display instruction is given. Accordingly, the operator can refer to the user's operation history in real time.

However, as the operator gives a predetermined instruction (termination instruction) of terminating the display of the moving image or the capture image included in the operation history image data, the display of the operation history image in the call center terminal 12 is ended.

Further, generation of the operation history image data is ended at a predetermined timing regardless of whether the display instruction has been given. In the first embodiment, generation of the operation history image data ended when the job is ended. Furthermore, when the generation of the operation history image data is ended, in other words, when the job is ended, the operation history image data stored in the HDD 146 of the image forming apparatus 14 is automatically erased.

Note that the timing at which the operation history image data is erased is not particularly limited. That is, the operation history image data may be erased after a predetermined period has elapsed from when the operation history image data is created, or may be erased sequentially in the order of oldness of the data when the storage capacity of the HDD 146 falls below a predetermined level.

The operation as described above of the information processing system 10 is realized as the CPU 122 of the call center terminal 12 executes an information processing program for the call center terminal 12 stored in the RAM 124, and the CPU 142 of the image forming apparatus 14 executes an information processing program for the image forming apparatus 14 stored in the RAM 144. The specific processing will be described later by referring to a flow chart.

FIG. 6 is an explanatory diagram showing one example of a memory map 70 of the RAM 124 of the call center terminal 12 shown in FIG. 2. As shown in FIG. 6, the RAM 124 includes a program storage area 72 and a data storage area 74. The program storage area 72 of the RAM 124 stores the information processing program for the call center terminal 12, as described above. The information processing program for the call center terminal 12 includes a display program 72a, an operation detection program 72b, a communication program 72c, an instruction detection program 72d, and an acquisition program 72e.

The display program 72a is a program for generating display image data related to various screens by using the image generation data 74b which will be described later, and outputting the display image data to the display 136. Also, the display program 72a is a program for generating, in a case where the display instruction is detected, the display image data for the operation history image data temporarily stored as the image generation data 74b, more specifically, screen data such as the moving image or capture image corresponding to the user's operation history image of the image forming apparatus 14, and outputting such data to the display 136.

The operation detection program 72b is a program for detecting the user's operation input from the input device 134, and the CPU 122 stores, in the RAM 124, the operation data acquired in accordance with the operation detection program 72b in chronological order.

The communication program 72c is a program for performing communication or the like with the image forming apparatus 14 via a network.

The instruction detection program 72d is a program for detecting the display instruction or the termination instruction, on the basis of the operation data acquired in accordance with the operation detection program 72b.

The acquisition program 72e is a program for temporarily storing the operation history image data, as the image generation data 74b, by periodically accessing the HDD 146 of the image forming apparatus 14 until the termination instruction is detected, from when the display instruction is detected. Here, when the HDD 146 of the image forming apparatus 14 is to be accessed, the communication program 72c is executed.

Though not illustrated, the program storage area 72 also stores programs for selecting and executing various functions provided in the call center terminal 12.

Also, the data storage area 74 of the RAM 124 stores operation input data 74a, the image generation data 74b, and the like.

The operation input data 74a is data in which operation data which has been detected in accordance with the operation detection program 72b is stored in chronological order.

The image generation data 74b is data such as polygon data or texture data for generating display image data corresponding to various screens to be displayed on the display 136. The image generation data 74b also includes data for generating display image data corresponding to the operation history image data acquired from the HDD 146 of the image forming apparatus 14.

Though not illustrated, in the data storage area 74, the other kinds of data necessary for executing the information processing program for the call center terminal 12 may be stored, or a timer (counter) or a register necessary for executing the information processing program for the call center terminal 12 may be provided.

FIG. 7 is an explanatory diagram showing one example of a memory map 80 of the RAM 144 of the image forming apparatus 14 shown in FIG. 2. As shown in FIG. 7, the RAM 144 includes a program storage area 82 and a data storage area 84. The program storage area 82 of the RAM 144 stores the information processing program for the image forming apparatus 14, as described above. The information processing program for the image forming apparatus 14 includes a display program 82a, an operation detection program 82b, a communication program 82c, a generation program 82d, and an erasure program 82e.

The display program 82a is a program for generating the display image data, more specifically, screen data such as the home screen 100, the copy setting screen 110 as described above, by using the image generation data 84b which will be described later, and outputting such data to the display 154.

The operation detection program 82b is a program for detecting a touch input, and the CPU 142 stores, in the RAM 144, touch coordinate data acquired in accordance with the operation detection program 82b in chronological order. However, as described above, in a case where a hardware button is provided and a case where a hardware keyboard is connected, input by the button or the key is also detected in accordance with the operation detection program 82b.

The communication program 82c is a program for performing communication with the call center terminal 12 via a network.

The generation program 82d is a program for generating the operation history image data related to a moving image or a capture image corresponding to the user's operation history image obtained from when an operation for executing the job is started, in other words, when the job is selected on the home screen 100. Note that the operation history image data generated in accordance with the generation program 82d is stored in the HDD 146.

The erasure program 82e is a program for erasing the operation history image data stored in the HDD 146 at a predetermined timing such as when the job is ended.

Though not illustrated, the program storage area 82 stores programs such as an image reading program for reading (scanning) an image of a document placed on a document placement table by controlling the image reader 158, and outputting an image signal (scan image data) corresponding to the read image, an image-forming program for forming a multicolored or monochrome image according to print image data 304c on a recording medium (paper sheet) by controlling the image former 156, a Fax control program for executing transmission and reception of facsimile, and a program for selecting and executing various functions provided in the image forming apparatus 14.

Also, the data storage area 84 of the RAM 144 stores operation input data 84a, the image generation data 84b, and the like.

The operation input data 84a is data in which touch coordinate data, which has been detected in accordance with the operation detection program 82b, is stored in chronological order. Note that the operation input data 84a may include operation data related to hardware buttons or keys.

The image generation data 84b is data such as polygon data or texture data for generating the display image data corresponding to various screens displayed on the display 154.

Though not illustrated, in the data storage area 84, the other kinds of data necessary for executing the information processing program for the image forming apparatus 14 may be stored, or a timer (counter) or a register necessary for executing the information processing program for the image forming apparatus 14 may be provided.

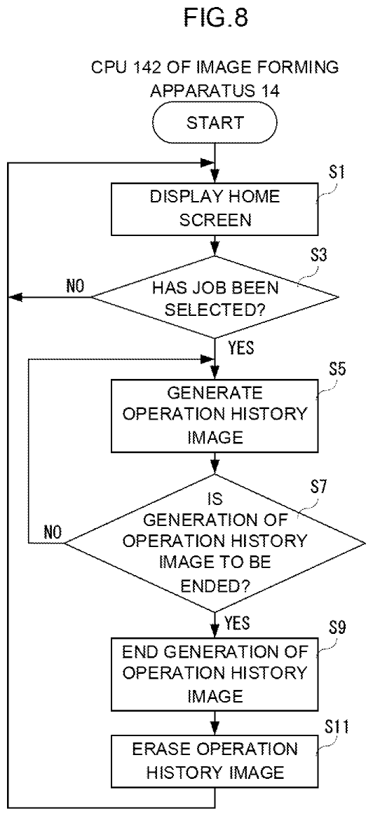

FIG. 8 is a flow chart showing one example of information processing executed by the CPU 142 of the image forming apparatus 14 shown in FIG. 3. The above-mentioned information processing is started when the image forming apparatus 14 is powered on.

As shown in FIG. 8, when the information processing is started, in step S1, the CPU 142 of the image forming apparatus 14 causes the display 154 to display the home screen 100. In step S3, the CPU 142 of the image forming apparatus 14 determines whether a job is selected. Here, it determined whether any of the icons 102 has been touched on the home screen 100. If step S3 is “NO”, in other words, if it is determined that no job has been selected, the process returns to step S1.

Meanwhile, if step S3 is “YES”, in other words, if it is determined that a job is selected, in step S5, an operation history image is generated. Data on the generated operation history image is stored in the HDD 146.

Next, step S7, whether to end the generation of the operation history image is determined. Here, it is determined whether the job is ended. If step S7 is “NO”, in other words, if it is determined that the generation of the operation history image is not to be ended, the process returns to step S5.

Meanwhile, if step S7 is “YES”, in other words, if it is determined that the generation of the operation history image is to be ended, in step S9, the generation of the operation history image is ended. Then, in step S11, data on the operation history image stored in the HDD 146 is erased, and the process returns to step S1.

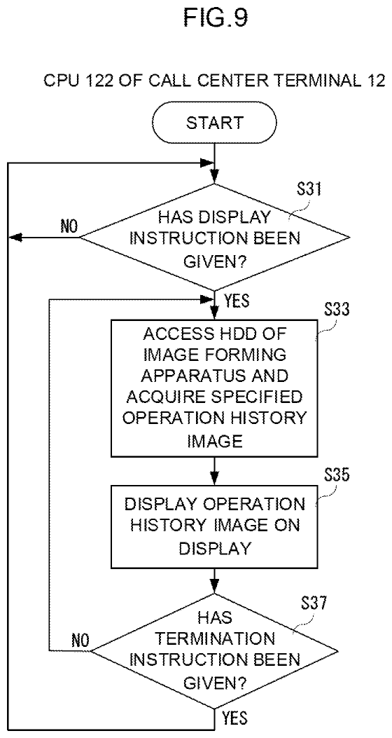

Next, the information processing executed by the CPU 122 of the call center terminal 12 will be described. FIG. 9 is a flow chart showing one example of the information processing executed by the CPU 122 of the call center terminal 12 shown in FIG. 1.

As shown in FIG. 9, when the information processing is started, the CPU 122 of the call center terminal 12 determines, in step S31, whether a display instruction has been given. If step S31 is “NO”, in other words, if it is determined that no display instruction has been given, the process returns to the same step, i.e., step S31.

Meanwhile, if step S31 is “YES”, in other words, if it is determined that a display instruction has been given, in step S33, the HDD 146 of the image forming apparatus 14 which stores the operation history image data specified by the operator is accessed, thereby acquiring the operation history image data in question. Further, in step S35, the operation history image included in the acquired operation history image data is displayed on the display 136, and in step S37, it is determined whether the termination instruction has been given.

If step S37 is “NO”, in other words, if it is determined that no termination instruction has been given, the process returns to step S33. Meanwhile, if step S37 is “YES”, in other words, if it is determined that the termination instruction has been given, the process returns to step S31.

In the first embodiment, the operator is enabled to confirm the operation history image corresponding to the user's operation history in the image forming apparatus 14. Accordingly, the operator can easily and accurately identify the user's operation history by referring to the user's operation history image, and provide appropriate guidance to the user.

### Second Embodiment

An information processing system 10 of a second embodiment has the same structure as that of the first embodiment except that identification information of an image forming apparatus 14 is transmitted to a call center terminal 12 when a predetermined instruction is received by the image forming apparatus 14. Therefore, only the parts different from the first embodiment will be explained, and redundant explanation will not be provided.

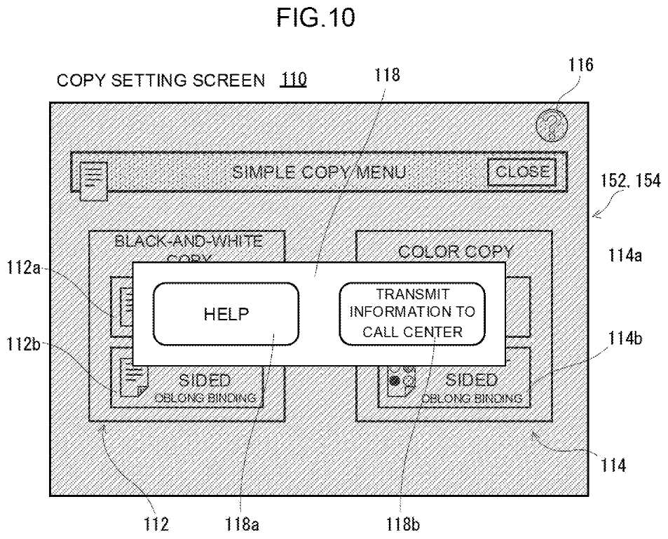

FIG. 10 is an explanatory diagram showing one example of a copy setting screen 110 of the second embodiment. When a help icon 116 is touched on each of operation screens including the copy setting screen 110, a function selection window 118 is displayed as shown in FIG. 10. Here, a case where the help icon 116 is touched on the copy setting screen 110 will be described as an example. The function selection window 118 is displayed at a central part of a display area of a display 154 to overlap a front surface of the copy setting screen 110. That is, the function selection window 118 is displayed in a pop-up manner.

The function selection window 118 is a screen (window) for executing the help mode or instructing transmission of the user's operation history, and the function selection window 118 is provided with a help mode execution icon 118a, and an information transmission icon 118b.

Though not illustrated, when the help mode execution icon 118a is touched, a help screen is displayed on the display 154. The help screen includes information for presenting a method of dealing with a trouble that has occurred in the image forming apparatus 14, details of the service that can be provided by the image forming apparatus 14, a method of operating the image forming apparatus 14, and the like, to the user.

In contrast, when the information transmission icon 118b is touched, identification information of the image forming apparatus 14 is transmitted to the call center terminal 12.

When an operator of a call center receives an inquiry from the user of the image forming apparatus 14, the operator instructs the user to touch the information transmission icon 118b. When the information transmission icon 118b is touched by the user, and the identification information of the image forming apparatus 14 is transmitted to the call center terminal 12, the operator identifies the image forming apparatus 14 being used by the user from the transmitted identification information, and gives a display instruction.

As described above, in the second embodiment, according to the identification information of the image forming apparatus 14 transmitted by the touching of the information transmission icon 118b, it is possible to identify the image forming apparatus 14 being used by the user. Therefore, even if the user makes an inquiry to the call center from a telephone other than a calling device 164 installed in the image forming apparatus 14, it is possible to identify the image forming apparatus 14 being used by the user. For this reason, in the image forming apparatus 14 of the second embodiment, the calling device 164 may be omitted. The information processing system 10 of the second embodiment is advantageous in a case where the user makes an inquiry to the call center by using a mobile phone such as a feature phone or a smartphone owned by the user, for example.

Also, in the second embodiment, in order to realize the operation as described above, an information processing program for the image forming apparatus 14 stored in a RAM 144 of the image forming apparatus 14 includes a transmission program or the like for transmitting the identification information of the image forming apparatus 14 to the call center terminal 12 when the information transmission icon 118b is touched. Here, when the identification information of the image forming apparatus 14 is to be transmitted to the call center terminal 12, a communication program 82c is executed. Also, an information processing program for the call center terminal 12 stored in a RAM 124 of the call center terminal 12 includes, for example, a reception program for receiving the identification information transmitted from the image forming apparatus 14. Here, when the identification information is to be received, a communication program 72c is executed.

Hereinafter, information processing executed by a CPU 142 of the image forming apparatus 14 in the second embodiment will be described by referring to a flowchart. The same reference symbols are assigned to processing that is the same as the information processing explained in the first embodiment, and explanation will be omitted or brief explanation is to be provided for duplicated matters.

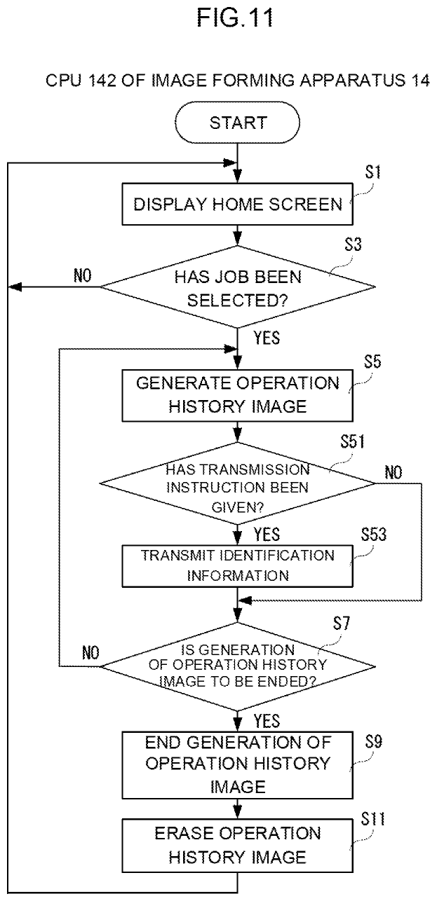

FIG. 11 is a flow chart showing one example of the information processing executed by the CPU 142 of the image forming apparatus 14 of the second embodiment. As shown in FIG. 11, when the information processing is started, the CPU 142 of the image forming apparatus 14 generates, in step S5, an operation history image, and determines, in step S51, whether a transmission instruction has been given. Here, it is determined whether the information transmission icon 118b has been touched. If step S51 is “NO”, in other words, if it is determined that no transmission instruction has been given, the process proceeds to step S7.

Meanwhile, if step S51 is “YES”, in other words, if it is determined that the transmission instruction has been given, the identification information of the image forming apparatus 14 is transmitted to the call center terminal 12 in step S53, and the process proceeds to step S7.

According to the second embodiment, similarly to the first embodiment, the operator can easily and accurately identify the user's operation history by referring to the user's operation history image, and provide appropriate guidance to the user.

### Third Embodiment

An information processing system 10 of a third embodiment has the same structure as that of the first embodiment except that operation history image data is stored in a server 16. Therefore, only the parts different from the first embodiment will be explained, and redundant explanation will not be provided.

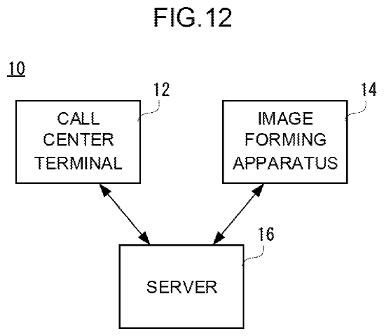

FIG. 12 is a diagram showing one example of the structure of the information processing system 10 of the third embodiment. As shown in FIG. 12, the information processing system 10 of the third embodiment includes the server 16, and the server 16 is communicably connected to a call center terminal 12 and an image forming apparatus 14 via a network.

The server 16 is a general-purpose server, and includes components such as a CPU, RAM, and a communication module. In addition, the server 16 includes a storage configured by non-volatile memories such as an HDD, an SSD, a flash memory, and an EEPROM. Note that the server 16 may be a cloud server.

In the information processing system 10 of the third embodiment, when the operation history image data is generated in the image forming apparatus 14, the generated operation history image data is transferred to the server 16, and is stored in the storage of the server 16. Further, when a display instruction is given, the call center terminal 12 accesses the storage of the server 16, and a moving image or a capture image included in the operation history image data is displayed on a display 136 of the call center terminal 12.

However, the operation history image data stored in the storage of the server 16 is automatically erased when the generation of the operation history image data is ended in the image forming apparatus 14, e.g., when a job is ended. Note that the operation history image data may be erased after a predetermined period has elapsed from when the operation history image data is created, or may be erased sequentially in the order of oldness of the data when the storage capacity of the storage of the server 16 falls below a predetermined level.

Further, in the third embodiment, in order to realize the operation as described above, an information processing program for the image forming apparatus 14 stored in a RAM 144 of the image forming apparatus 14 includes a transmission program for transmitting the operation history image data to the server 16, an erasure instruction program for transmitting an erasure command which instructs the server 16 to erase the operation history image data when the generation of the operation history image data is ended, and the like. Here, when the operation history image data or the erasure command is to be transmitted to the server 16, a communication program 82c is executed. An acquisition program 72e included in an information processing program for the call center terminal 12 is a program for temporarily storing the operation history image data, as image generation data 74b, by accessing the storage of the server 16 when the display instruction is detected.

Hereinafter, information processing executed by a CPU 142 of the image forming apparatus 14 and information processing executed by a CPU 122 of the call center terminal 12 in the third embodiment will be described by referring to a flowchart. The same reference symbols are assigned to processing that is the same as the information processing explained in the first embodiment, and explanation will be omitted or brief explanation is to be provided for duplicated matters.

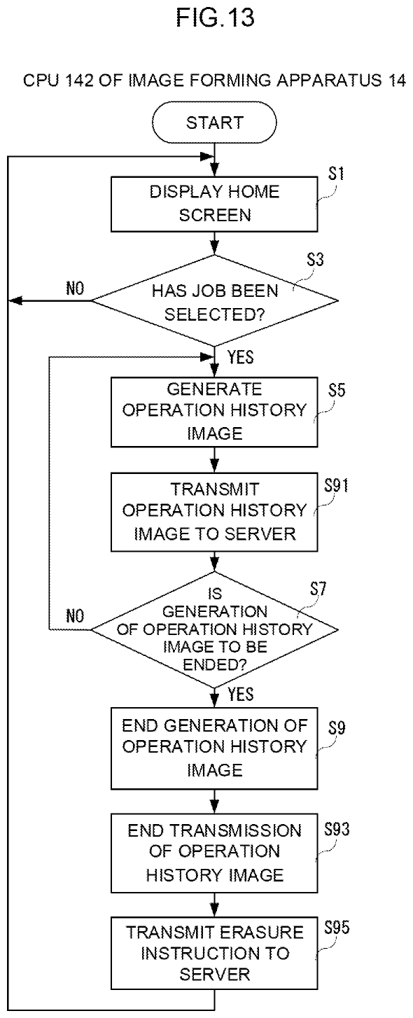

FIG. 13 is a flow chart showing one example of the information processing executed by the CPU 142 of the image forming apparatus 14 of the third embodiment. As shown in FIG. 13, when the information processing is started, the CPU 142 of the image forming apparatus 14 generates, in step S5, an operation history image, transmits, in step S91, the operation history image to the server 16, and proceeds to step S7. Further, if step S7 is “YES”, the generation of the operation history image is ended in step S9, the transmission of the operation history image is ended in step S93, an erasure command for the operation history image is transmitted to the server 16 in step S95, and the process proceeds to step S1.

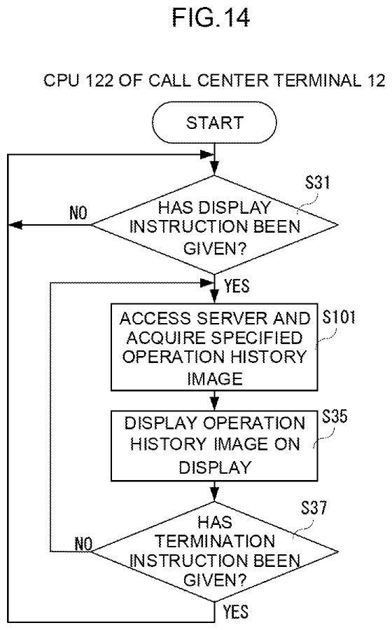

Next, the information processing executed by the CPU 122 of the call center terminal 12 will be described. FIG. 14 is a flow chart showing one example of the information processing executed by the CPU 122 of the call center terminal 12 of the third embodiment. As shown in FIG. 14, when the information processing is started, if step S31 is “YES”,the CPU 122 of the call center terminal 12 accesses the storage of the server 16 and acquires the operation history image data specified by an operator in step S101, and proceeds to step S35.

According to the third embodiment, similarly to the first embodiment, the operator can easily and accurately identify the user's operation history by referring to the user's operation history image, and provide appropriate guidance to the user.

Also, according to the third embodiment, since the operation history image data is stored in the server 16, the amount of data stored in an HDD 146 of the image forming apparatus 14 can be reduced. Therefore, as the HDD 146 of the image forming apparatus 14, an HDD having a relatively low storage capacity or the other non-volatile memories can be adopted.

Note that an embodiment shown in the third embodiment can also be combined with the second embodiment in adopting the embodiment.

Further, the screens, the specific configurations, and the like described in the above embodiments are merely examples, and can be appropriately modified according to the actual product.

Furthermore, the embodiment described above is structured such that the call center terminal 12 accesses the HDD 146 of the image forming apparatus 14 or the storage of the server 16 to acquire the operation history image data when a display instruction is given. However, the structure need not be limited to the above. For example, when a display instruction is given, the operation history image data may be transmitted from the image forming apparatus 14 or the server 16 to the call center terminal 12 and temporarily stored in an HDD 126. In this case, the operation history image data is read from the HDD 126 to a RAM 124 as appropriate, and display image data related to the operation history image is generated to be output to a display 136.

Furthermore, the embodiments described above are structured such that the image forming apparatus 14 is identified by the identification information of the calling device 164, or by the identification information of the image forming apparatus 14 which is transmitted by the touching of the information transmission icon 118b. However, the structure need not be limited to the above. For example, the operator of the call center may ask the user to tell the place where the image forming apparatus 14 in use is installed, in other words, the place where the user is at, to identify the image forming apparatus 14 being used by the user in question.

What is claimed is:

1. An information processing system comprising:
an image forming apparatus capable of executing a predetermined job;
an information processor operated by an operator of a call center; and
a storage, wherein
the image forming apparatus includes:
a first display;
a first display controller which causes an operation screen to be displayed on the first display by switching a plurality of operation screens for executing the predetermined job; and
a generator which generates an operation history image corresponding to a user's operation history from when an operation for executing the predetermined job is started,
the storage stores the operation history image generated by the generator, and
the information processor includes:
a second display;
an acquirer which accesses the storage to acquire the operation history image; and
a second display controller which causes the operation history image acquired by the acquirer to be displayed on the second display.

2. The information processing system according to claim 1, wherein
the information processor further includes an operation portion which receives an operation of the operator, and
the acquirer accesses the storage when a predetermined operation is received by the operation portion.

3. The information processing system according to claim 1, wherein the storage is provided in the image forming apparatus.

4. The information processing system according to claim 1, wherein
the information processing system further includes a server provided to be communicable with the image forming apparatus and the information processor, and
the storage is provided in the server.

5. The information processing system according to claim 1, wherein the operation history image includes a moving image corresponding to the operation screen displayed on the first display from when the operation for executing the predetermined job is started.

6. The information processing system according to claim 1, wherein the operation history image includes a plurality of still images corresponding to the operation screen displayed on the first display from when the operation for executing the predetermined job is started.

7. A method of confirming an operation history in an information processing system including: an image forming apparatus provided with a first display and capable of executing a predetermined job; an information processor which is provided with a second display and is operated by an operator of a call center; and a storage,
the method comprising:
(a) causing an operation screen to be displayed on the first display by switching a plurality of operation screens for executing the predetermined job;
(b) generating an operation history image corresponding to a user's operation history in the image forming apparatus from when an operation for executing the predetermined job is started;
(c) causing the operation history image, which is generated in generating the operation history image, to be stored in the storage;
(d) causing the information processor to access the storage and acquire the operation history image; and
(e) causing the operation history image, which is acquired by the information processor, to be displayed on the second display.
